(19) United States
(12) Patent Application Publication
(10) Pub. No.: US 2009/0189877 A1
(43) Pub. Date: Jul. 30, 2009

(54) TOUCH PANEL DEVICE AND USER INTERFACE DEVICE

(76) Inventors: Hiroyuki WASHINO, Tokyo (JP); Yuichi OKANO, Tokyo (JP); Takenori KAWAMATA, Tokyo (JP)

Correspondence Address: BIRCH STEWART KOLASCH & BIRCH, PO BOX 747, FALLS CHURCH, VA, 22040-0747, US

(21) Appl. No.: 12/349,967

(22) Filed: Jan. 7, 2009

(30) Foreign Application Priority Data
Jan. 25, 2008 (JP) 2008-15000

(51) Int. Cl. G06F 3/045

(52) U.S. Cl. 345/174

(57) ABSTRACT

An analog touch panel device capable of utilizing a two-point touch on a touch panel as meaningful information input and a user interface device employing the analog touch panel device are provided. A decision is made as to whether two points are touched or not on a touch panel TP having resistive films which have electrode terminals at opposite end portions each and are superimposed top and bottom in such a manner that the electrode terminals become orthogonal, in which the top and bottom resistive films are brought into contact with each other by a push of a resistive film surface by touch input. The decision is made according to resistance values between the opposite terminals, and when a decision is made that the two points are touched, the distance between the two points touched is detected according to the resistance values between the opposite terminals.

### BACKGROUND OF THE INVENTION

1. Field of the Invention

The present invention relates to a touch panel device and a user interface device using it.

2. Description of Related Art

As a touch panel device for deciding touching on a plurality of points on a touch panel, there is one disclosed in Patent Document 1, for example. The device of Patent Document 1 utilizes a phenomenon that when a plurality of points are touched on the touch panel, a resistance value between opposite terminals on a two-layer touch panel reduces. To be concrete, to prevent a malfunction due to touching on a plurality of points on the touch panel, it makes a decision that the plurality of points are touched only when the resistance value between the opposite terminals of the touch panel measured varies greater than a reference value.

Patent Document 1: Japanese Patent Laid-Open No. 8-241161/1996

### SUMMARY OF THE INVENTION

The analog touch panel device utilizing the resistance values between opposite terminals as described above can perform coordinate detection at a higher resolution than a digital (matrix) type that has electrodes arranged in a matrix on a touch panel, and facilitate a big screen, thereby offering an advantage in the manufacturing cost.

The conventional analog touch panel device, however, has a problem of being unable to realize a user interface device that utilizes a two-point touch as meaningful information input, which is achieved by the digital type touch panel device. For example, as for the device of Patent Document 1, although it can detect a two-point touch, it aims at preventing a malfunction, and does not consider utilizing the two-point touch as the meaningful information input at all.

The present invention is implemented to solve the foregoing problem. It is therefore an object of the present invention to provide an analog touch panel device capable of utilizing a two-point touch on a touch panel as meaningful information input, and a user interface device using it.

A touch panel device in accordance with the present invention includes a touch panel having resistive films which have electrode terminals at opposite end portions each and are superimposed top and bottom in a manner that the electrode terminals become orthogonal, wherein the top and bottom resistive films are brought into contact with each other by pushing a resistive film surface by touch input, the touch panel device comprising: a coordinate detecting section for detecting coordinates of a touch position from voltage values between the electrode terminals and the touch position at which the resistive films make contact top and bottom in response to the touch input onto the touch panel; an inter-opposite-terminal resistance measuring section for measuring resistance values between the opposite electrode terminals of the top and bottom resistive films; a two-point touch deciding section for making a decision as to whether two points on the touch panel are touched or not from the resistance values between the opposite electrode terminals measured by the inter-opposite-terminal resistance measuring section; and a point-to-point distance detecting section for detecting, when the two-point touch deciding section decides that the two points are touched, the distance between the two points touched from the resistance values between the opposite electrode terminals measured by the inter-opposite-terminal resistance measuring section.

According to the present invention, a decision is made as to whether two points are touched or not on the touch panel according to the resistance values between the opposite terminals, the touch panel having resistive films which have electrode terminals at opposite end portions each and are superimposed top and bottom in such a manner that the electrode terminals become orthogonal, the top and bottom resistive films being brought into contact with each other by pushing a resistive film surface by touch input. When a decision is made that the two points are touched, the distance between the two points touched is detected according to the resistance values between the opposite electrode terminals. The configuration offers an advantage of being able to realize the user interface utilizing the distance between the two points due to the two-point touch on the analog touch panel as meaningful input information.

### BRIEF DESCRIPTION OF THE DRAWINGS

FIG. 1 is a circuit diagram showing a configuration of a touch panel device of an embodiment 1 in accordance with the present invention;

FIG. 2 is a block diagram showing a functional configuration of the touch panel device in FIG. 1;

FIG. 3 is a flowchart showing a flow of xy coordinate detection processing, decision processing on whether two points are touched or not, and detection processing of a distance between the two points by the touch panel device of the embodiment 1;

FIG. 4 is a flowchart showing a flow of the processing of detecting the xy coordinates of a touch position;

FIG. 5 is a schematic diagram showing an equivalent circuit of a touch panel TP at touch input;

FIG. 6 is a flowchart showing a flow of the measurement processing of the resistance values between opposite terminals;

FIG. 7 is a diagram showing an equivalent circuit configuration between opposite terminals X1 and X2 at a time when touching a single point on the touch panel TP;

FIG. 8 is a diagram showing an equivalent circuit configuration between the opposite terminals X1 and X2 at a time when touching two points on the touch panel TP;

FIG. 9 is a block diagram showing a configuration of a touch panel device of an embodiment 2 in accordance with the present invention;

FIG. 10 is a flowchart showing a flow of xy coordinate detection processing, decision processing on whether two points are touched or not, and detection processing of a distance between the two points by the touch panel device of the embodiment 2;

FIG. 11 is a diagram showing an equivalent circuit configuration between orthogonal terminals X1 and Y2 at a time when touching a single point on the touch panel TP;

FIG. 12 is a diagram showing an equivalent circuit configuration between the orthogonal terminals X1 and Y2 at a time when touching two points on the touch panel TP;

FIG. 13 is a flowchart showing a flow of xy coordinate detection processing, decision processing on whether two points are touched or not, and detection processing of a distance between the two points by the touch panel device of an embodiment 3 in accordance with the present invention;

FIG. 14 is a block diagram showing a configuration of a touch panel device of an embodiment 4 in accordance with the present invention;

FIG. 15 is a flowchart showing a flow of the operation of a user interface device of the embodiment 4;

FIG. 16 is a flowchart showing a detailed flow of the processing designated by the reference symbol A in FIG. 15, which displays an image or document with its scale being enlarged or reduced in accordance with the distance between the two points;

FIG. 17 is a diagram for explaining alteration processing of display contents in accordance with the distance between the two points due to a two-point touch;

FIG. 18 is a flowchart showing a flow of the operation of a user interface device of the embodiment 5;

FIG. 19 is a flowchart showing a detailed flow of the processing designated by the reference symbol B in FIG. 18, which displays an image or document with its scale being enlarged or reduced in accordance with the xy coordinates near the middle point between the two points and the distance between the two points;

FIG. 20 is a diagram for explaining alteration processing of display contents in accordance with the xy coordinates near the middle point between the two points due to a two-point touch and the distance between the two points;

FIG. 21 is a flowchart showing a flow of the processing designated by the reference symbol B in FIG. 18 in the user interface device of an embodiment 6 in accordance with the present invention;

FIG. 22 is a diagram for explaining the x and y direction distance differences between two points at one unit time before and at the present time; and

FIG. 23 is a diagram for explaining processing of rotation display of the display contents about the xy coordinates near the middle point between the two points due to a two-point touch.

### EXPLANATION OF SYMBOLS

1 xy coordinate detecting section; 2 inter-opposite-terminal resistance measuring section; 3 two-point touch deciding section; 4 point-to-point distance detecting section; 5 xy coordinate output section; 6 point-to-point distance output section; 7 control section; 8 signal line; 9 inter-orthogonal-terminal resistance measuring section; A input/output device; ADX1, ADY1, ADX2, ADY2 LCD input port; B processing device; C storage device; C1 point-to-point distance storage buffer (storage section), GND ground; L1 LCD unit; Ml microcontroller; P0-P7 output port; SW1-SW8 switch; TP touch panel; TP1, TP2 resistive film; VCC power supply; X1, X2, Y1, Y2 terminal (electrode terminal).

### DETAILED DESCRIPTION OF THE PREFERRED EMBODIMENTS

### Embodiment 1

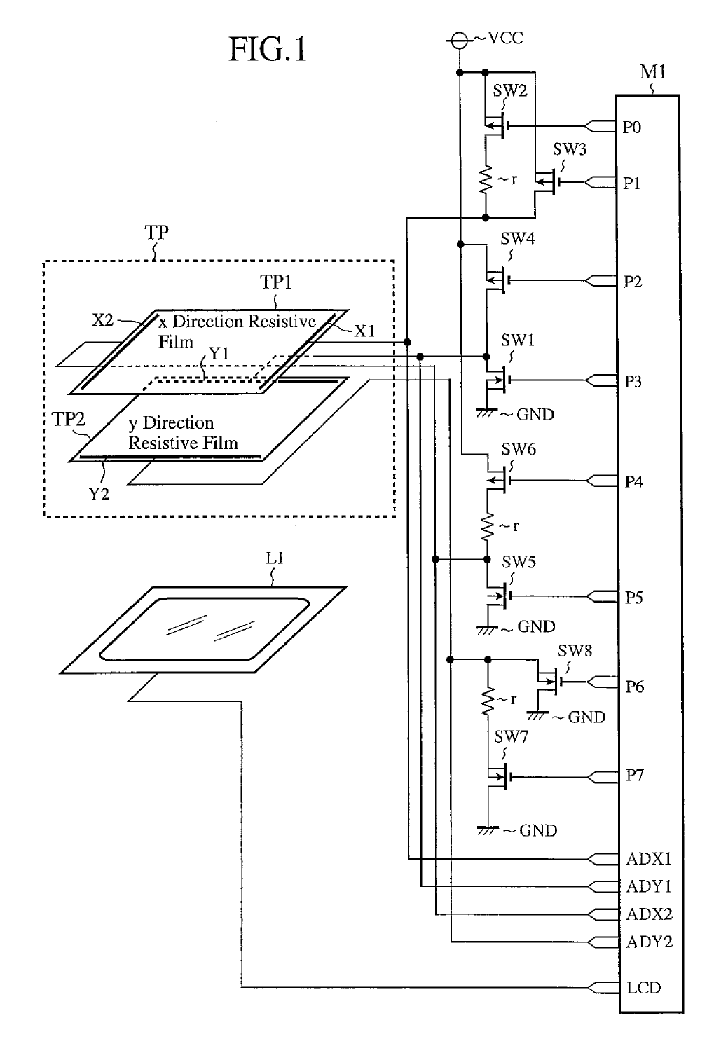

FIG. 1 is a circuit diagram showing a configuration of a touch panel device of an embodiment 1 in accordance with the present invention. In FIG. 1, a touch panel TP has two analog resistive films TP1 and TP2. The resistive film TP1 (referred to as “x direction resistive film TP1” from now on) has terminals (electrode terminals) X1 and X2 which consist of a pair of electrodes provided at both edges in the x direction. Likewise, the resistive film TP2 (referred to as “y direction resistive film TP2” from now on) has terminals (electrode terminals) Y1 and Y2 which consist of a pair of electrodes provided at both edges in the y direction (direction perpendicular to the X direction). Thus, the touch panel TP has the two resistive films TP1 and TP2 superimposed in such a manner that the terminals X1 and X2 and terminals Y1 and Y2 become orthogonal.

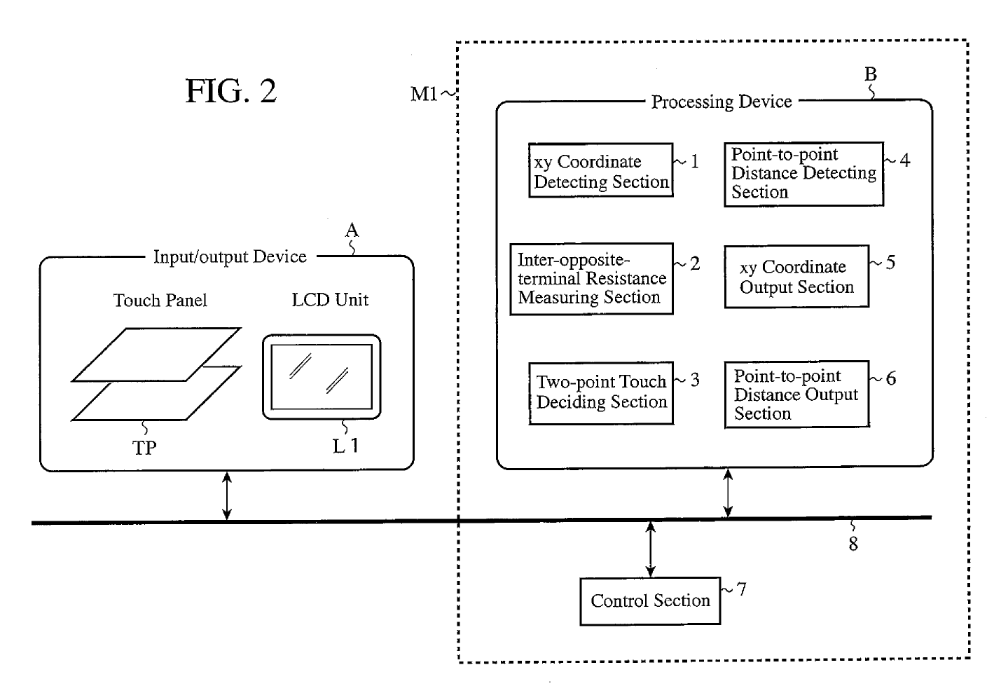

A microcontroller M1 is a component for detecting a touch position on the touch panel TP and for causing an LCD unit L1 to display information. It includes a CPU and a memory not shown and input/output ports, and includes a processing device B, a control section 7 and a storage device C, which will be described later with reference to FIG. 2. The output ports P0-P7 of the microcontroller M1 are connected to the gate terminals of transistors such as MOSFETs constituting switches SW2, SW3, SW4, SW1, SW6, SW5, SW8 and SW7, respectively. The switches SW1-SW8 can be switched by output settings to the output ports P0-P7.

The switch SW2 has its source terminal connected to a power supply VCC for applying specified DC voltage and to the source terminal of the switch SW3; and has its drain terminal connected to a first terminal of a resistance r. The switch SW3 has its drain terminal connected to a second terminal of the resistance r connected to the drain terminal of the switch SW2, and to an input port ADX1 and the terminal X1 of the resistive film TP1. The switch SW4 has its source terminal connected to the power supply VCC and to the source terminal of the switch SW6; and its drain terminal connected to the drain terminal of the switch SW1, to an input ports ADY1 and to the terminal Y1 of the resistive film TP2. The switch SW1 has its source terminal grounded to a ground GND.

The switch SW6 has its source terminal connected to the DC power supply VCC, and its drain terminal connected to a first terminal of a resistance r. The switch SW5 has its drain terminal connected to a second terminal of the resistance r connected to the drain terminal of the switch SW6, and to an input port ADX2 and to the terminal X2 of the resistive film TP1; and has its source terminal grounded to the ground GND. The switch SW8 has its drain terminal connected to the drain terminal of the switch SW7, to an input port ADY2 and to the terminal Y2 of the resistive film TP2; and has its source terminal grounded to the ground GND. The switch SW7 has its drain terminal connected to the drain terminal of the switch SW8, to an input port ADY2 and to the electrode Y2 of the resistive film TP2; and its source terminal grounded to the ground GND.

The microcontroller M1 has its input ports ADX1, ADY1, ADX2 and ADY2 connected to the terminals X1, Y1, X2 and Y2, respectively. The analog voltage signals which are produced at the terminals X1, Y1, X2 and Y2 in response to a touch onto a panel and indicate changes in the resistance values are input to an A/D converter not shown within the microcontroller M1. The A/D converter converts the analog voltage signals fed from the terminals X1, Y1, X2 and Y2 to digital data, and supplies them to a processing section of the microcontroller M1 not shown. An LCD unit L1 is disposed under the two resistive films TP1 and TP2 superimposed on each other, and displays information contents which are fed from the microcontroller M1 via an output port LCD and form a target to be touched on the LCD screen.

FIG. 2 is a block diagram showing a functional configuration of the touch panel input device in FIG. 1. As shown in FIG. 2, the touch panel input device of the embodiment 1 has an input/output device A, a processing device B and a control section 7, which are connected to one another via a signal line 8. The input/output device A consists of the touch panel TP and LCD unit L1 shown in FIG. 1, and the processing device B and control section 7 are constructed on the microcontroller M1 shown in FIG. 1 as indicated by broken lines in FIG. 2.

In the input/output device A, the touch panel TP outputs analog voltages indicating resistance changes in the resistive films in accordance with the position on the panel that is touch input. The LCD unit L1 displays display contents on the LCD screen according to instructions from the control section 7. The LCD unit L1 is disposed under the two resistive films superimposed.

The processing device B has an xy coordinate detecting section 1, an inter-opposite-terminal resistance measuring section 2, a two-point touch deciding section 3, a point-to-point distance detecting section 4, an xy coordinate output section 5 and a point-to-point distance output section 6. It not only detects a position touched on the touch panel TP and carries out the processing of generating information to be displayed on the LCD unit L1, but also performs the processing of deciding on whether two points are touched or not and the processing of detecting the distance between the two points. The xy coordinate detecting section 1 detects the xy coordinates of the touch position on the touch panel TP. The inter-opposite-terminal resistance measuring section 2 measures the resistance values between the opposite terminals X1 and X2 and Y1 and Y2 (referred to as “resistance values between opposite terminals” from now on) at both edges of the two resistive films TP1 and TP2.

The two-point touch deciding section 3 makes a decision as to whether two points are touched or not on the touch panel TP. When the two-point touch deciding section 3 decides that the two-point touch is made, the point-to-point distance detecting section 4 detects the distance between the two points. The xy coordinate output section 5 outputs the xy coordinates indicating the position touched on the panel (at a time when a single point is touched) to the control section 7. The point-to-point distance output section 6 outputs, when two points are touched on the panel, the distance between the two points to the control section 7. The control section 7 performs operation control of all the processing sections constituting the processing device B, and controls data transfer between the input/output device A and the processing device B.

As for the xy coordinate detecting section 1, inter-opposite-terminal resistance measuring section 2, two-point touch deciding section 3, point-to-point distance detecting section 4, xy coordinate output section 5 and point-to-point distance output section 6 constituting the processing device B, and the control section 7, they can be embodied in a concrete means that has the switches SW1-SW8 and the hardware and software of the microcontroller M1 operate in cooperation with the CPU within the microcontroller M1, which is not shown in FIG. 1 but reads a touch panel control program conforming the gist of the present invention from a memory and executes the program.

Next, the operation will be described.

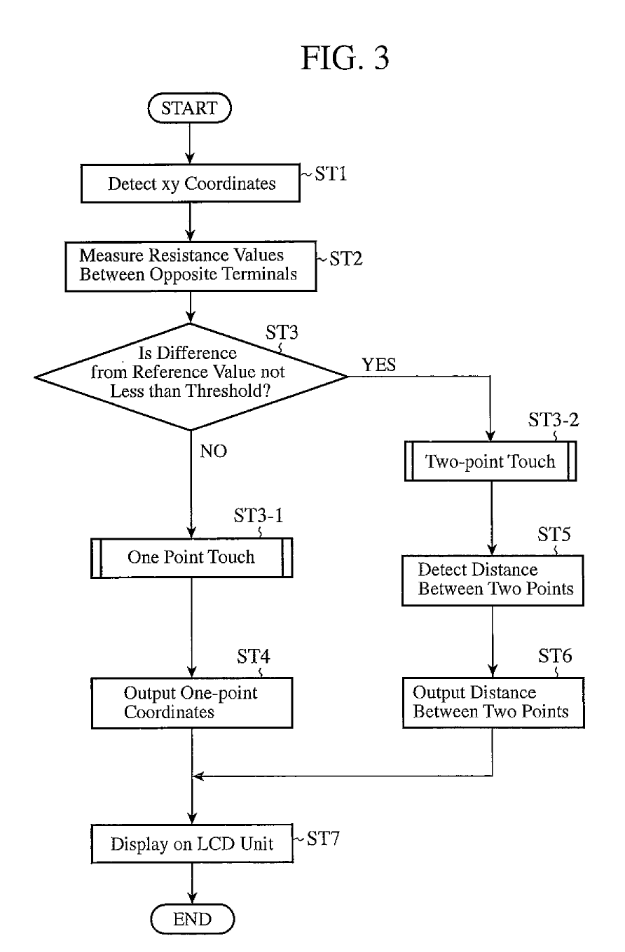

FIG. 3 is a flowchart showing a flow of the xy coordinate detection processing, the decision processing as to whether two points are touched or not, and the processing of detecting the distance between the two points by the touch panel device of the embodiment 1. The details of the processing will be described with reference to FIG. 3 besides FIG. 1 and FIG. 2.

First, the xy coordinate detecting section 1 of the processing device B detects the xy coordinates of the position which is touch input on the touch panel TP (step ST1).

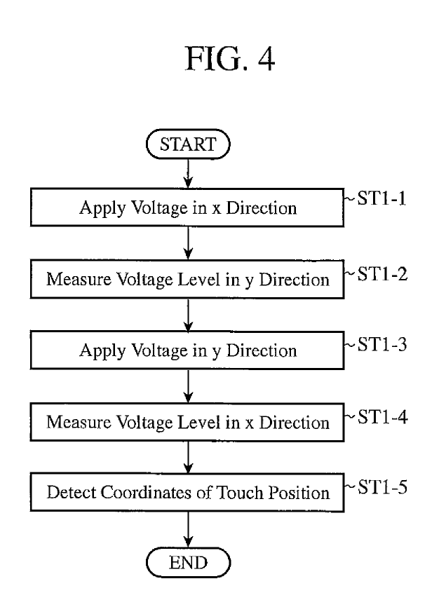

FIG. 4 is a flowchart showing a flow of the processing of detecting the xy coordinates of the touch position. The control section 7 shown in FIG. 1 controls the output setting of the output ports P0-P7, turns on only the switches SW3 and SW5, and turns off all the other switches so that the DC voltage of the power supply VCC is applied across the terminals X1 and X2 of the x direction resistive film TP1 (step ST1-1).

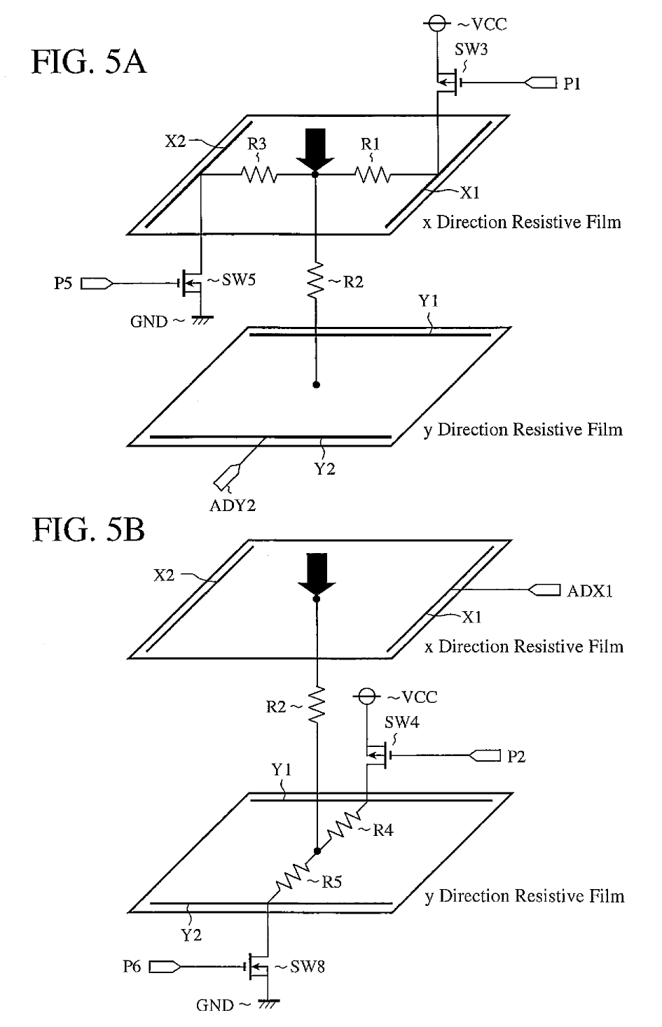

FIG. 5(a) is a schematic diagram showing an equivalent circuit of the touch panel TP in the case where the touch input is given while the voltage is applied across the terminals X1 and X2. It shows a case where the panel is pushed down in the direction of the arrow in FIG. 5(a). When a single point is touched while only the switches SW3 and SW5 are in the ON state as shown in FIG. 5(a); a circuit is formed which has resistances from the position touched on the x direction resistive film TP1 to both the terminals X1 and X2 (whose resistance values are R1 and R3) connected in series across the power supply VCC and the ground GND. In this case, although the y direction resistive film TP2 is connected to the position touched via a contact resistance (whose resistance value is R2), no current flows through the contact resistance. Thus, they direction resistive film TP2 has the same potential as the position touched.

In this state, the control section 7 measures the voltage level at the terminal Y2 (or terminal Y1) via the input port ADY2 (step ST1-2), thereby acquiring the voltage level at the position touched in the x direction. Likewise, the control section 7 controls the output setting of the output ports P0-P7, turns on only the switches SW4 and SW8, and turns off all the other switch. Thus, the DC voltage of the power supply VCC is applied across the terminals Y1 and Y2 of the y direction resistive film TP2 (step ST1-3).

FIG. 5(b) is a schematic diagram showing an equivalent circuit of the touch panel TP in the case where the touch input is given while the voltage is applied across the terminals Y1 and Y2. It shows a case where the panel is pushed down in the direction of the arrow in FIG. 5(b). When a particular point is touched while only the switches SW4 and SW8 are in the ON state as shown in FIG. 5(b), a circuit is formed which has resistances from the position touched on the y direction resistive film TP2 to both the terminals Y1 and Y2 (whose resistance values are R4 and R5) connected in series across the power supply VCC and the ground GND.

In this case, although the x direction resistive film TP2 is connected to the position touched via a contact resistance (whose resistance value is R2), no current flows through the contact resistance. Thus, the x direction resistive film TP1 has the same potential as the position touched. In this state, the control section 7 measures the voltage level at the terminal X1 (or terminal X2) via the input port ADX1 (step ST1-4), thereby acquiring the voltage level at the position touched in the y direction.

The voltage levels in the x direction and y direction at the position touched are delivered from the control section 7 to the xy coordinate detecting section 1 of the processing device B. Here, the voltage levels in the x direction and y direction at the position touched are equal to the voltages obtained by dividing the voltage applied from the power supply VCC by the resistance value R1 and the resistance value R3, and the resistance value R4 and the resistance value RS, respectively. Since the x coordinate proportional to the potential gradient in the x direction on the resistive film TP1 and the y coordinate proportional to the potential gradient in the y direction on the resistive film TP2 are known, the xy coordinate detecting section 1 calculates the xy coordinates indicating the position touched using the voltage levels in the x direction and y direction at the position touched obtained as described above (step ST1-5).

Let us return to the description of FIG. 3. Once the xy coordinates of the touched position has been obtained at step ST1, the inter-opposite-terminal resistance measuring section 2 of the processing device B measures the resistance value across the opposite terminals X1 and X2 at both ends of the x direction resistive film TP1 and the resistance value across the opposite terminals Y1 and Y2 at both ends of the y direction resistive film TP2.

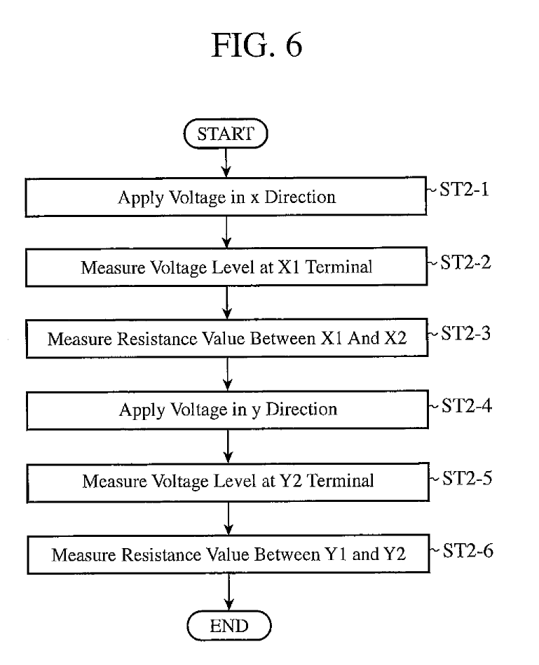

FIG. 6 is a flowchart showing a flow of the measurement processing of the resistances between the opposite terminals.

First, the control section 7 applies the DC voltage of the power supply VCC between the terminals X1 and X2 of the x direction resistive film TP1 via the reference resistance r by turning on only the switches SW2 and SW5 and turning off all the other switches by controlling the output setting of the output ports P0-P7 (step ST2-1)

In this state, the control section 7 measures the voltage level at the terminal X1 via the input port ADX1 (step ST2-2). In this case, the voltage level at the terminal X1 measured equals the value obtained by dividing the applied voltage by the resistance value between the terminals X1 and X2 of the x direction resistive film TP1 and the known reference resistance value r. Thus, the resistance value across the opposite terminals X1 and X2 of the x direction resistive film TP1 can be obtained (step ST2-3).

Next, the control section 7 applies the DC voltage of the power supply VCC between the terminals Y1 and Y2 of the y direction resistive film TP2 via the reference resistance r by turning on only the switches SW4 and SW7 and turning off all the other switches by controlling the output setting of the output ports P0-P7 (step ST2-4).

In this state, the control section 7 measures the voltage level of the terminal Y2 via the input port ADY2 (step ST2-5). In this case, the voltage level of the terminal Y2 measured equals the value obtained by dividing the applied voltage by the resistance value between the terminals Y1 and Y2 of the y direction resistive film TP2 and the known reference resistance value r. Accordingly, the resistance value across the opposite terminals Y1 and Y2 of the y direction resistive film TP2 can be obtained (step ST2-6).

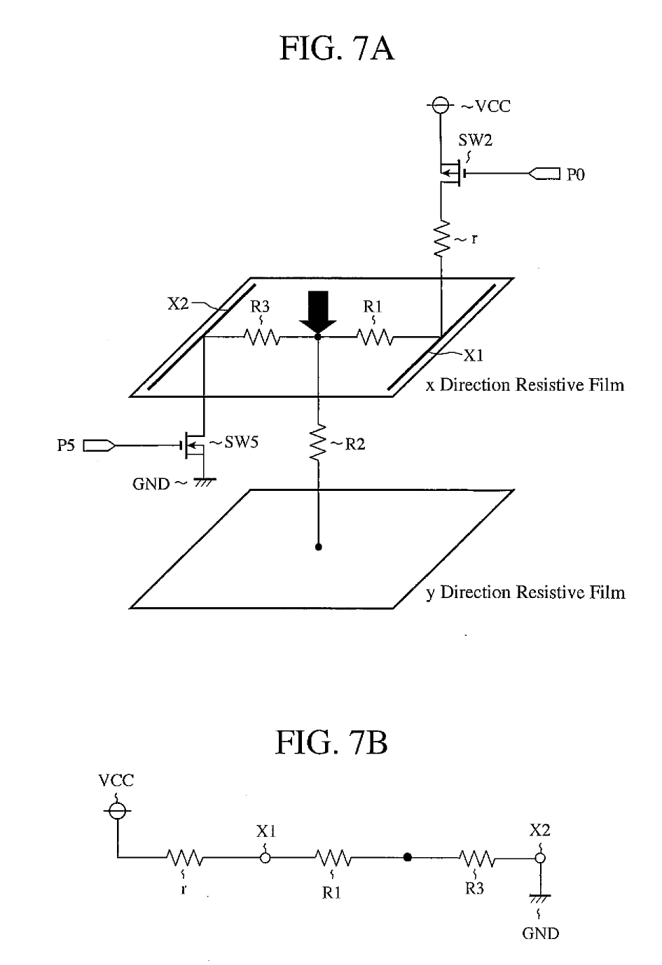

Here, the principle of the phenomenon that the resistance value between the opposite terminals reduces when two points on the panel are touch as compared with when only one point is touched will be described by dividing into the cases where one point is touched and two points are touched. FIG. 7 is a diagram showing an equivalent circuit configuration across the opposite terminals X1 and X2 when one point on the touch panel TP is touched: FIG. 7(a) shows a schematic equivalent circuit when one point is touched; and FIG. 7(b) is an equivalent circuit when one point is touched. When the panel is pushed down at one point in the direction as indicated by the arrow in FIG. 7(a) in the state where the voltage VCC is applied between the opposite terminals X1 and X2 via the reference resistance r, a circuit is formed having the resistances (resistance values R1 and R3) connected in series across the terminals X1 and X2 from the position touched on the x direction resistive film TP1 to both the terminals X1 and X2 as shown in FIG. 7(b).

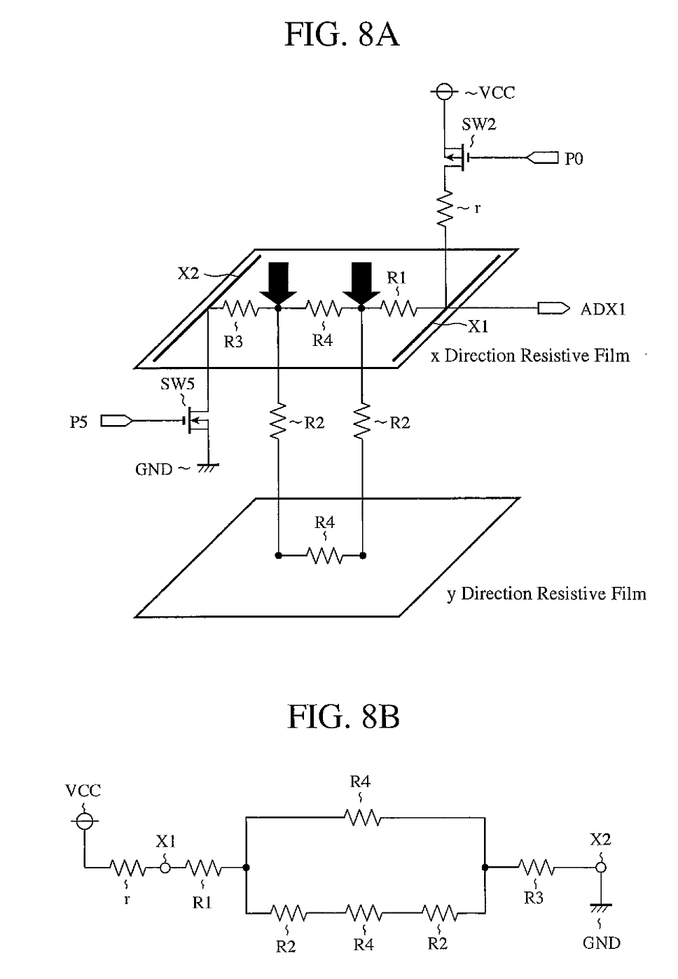

FIG. 8 is a diagram showing an equivalent circuit configuration between the opposite terminals X1 and X2 when two points on the panel of the touch panel TP are touched: FIG. 8(a) shows a schematic equivalent circuit when two points are touched; and FIG. 8(b) is an equivalent circuit when two points are touched. When the panel is pushed down at two points in the direction as indicated by the arrows in FIG. 8(a) in the state where the voltage VCC is applied across the opposite terminals X1 and X2 via the reference resistance r, a circuit is formed across the opposite terminals X1 and X2, the circuit having, between the resistances (resistance values R1 and R3) from the two points touched on the x direction resistive film TP1 to the terminals X1 and X2, a parallel circuit of the resistance (resistance value R4) across the two points on the x direction resistive film TP1 and the resistance (resistance value R4) across the two points on the y direction resistive film TP2 and the contact resistances (resistance value R2) as shown in FIG. 8(b). Thus, the phenomenon occurs that the resistance value across the opposite terminals X1 and X2 reduces by an amount the parallel circuit is formed compared with the case where one point is touched as shown in FIG. 7. Likewise, a phenomenon occurs that the resistance value reduces across the opposite terminals Y1 and Y2 at both ends on the y direction resistive film TP2.

Let us return to the description of FIG. 3. According to the foregoing principle, the two-point touch deciding section 3 receives information on the resistance value between the opposite terminals measured at step ST2 and a specified reference value, calculates the difference between them and makes a decision as to whether the difference is equal to or greater than the specified threshold (step ST3). As for the specified reference value in this case, it is preferably equal to the resistance value between opposite terminals when one point is touched on the panel.

At step ST3, if the difference between the resistance value between opposite terminals and the reference value is less than the threshold, the two-point touch deciding section 3 makes a decision that only one point is touched (step ST3-1), and notifies the xy coordinate output section 5 of the decision result. Receiving it from the two-point touch deciding section 3, the xy coordinate output section 5 receives the xy coordinates of the position detected at step ST1 from the xy coordinate detecting section 1, and outputs it to the control section 7 (step ST4). The control section 7 supplies the LCD unit L1 with an appropriate instruction (such as displaying a mouse cursor at the xy coordinates) based on the information on the xy coordinates input. Thus, the LCD unit L1 displays the information corresponding to the touch position on the LCD screen (step ST7).

In contrast, if the difference between the resistance across opposite terminals and the reference value is greater than the threshold at step ST3, the two-point touch deciding section 3 makes a decision that the two points are touched (step ST3-2) and notifies the point-to-point distance detecting section 4 of the decision result. Receiving the decision result indicating that the two points are touched, the point-to-point distance detecting section 4 receives the resistance values between the opposite terminals measured at step ST2, and detects the distance between the two points (step ST5). Here, a method of detecting the distance between the two points by utilizing the resistance values between the opposite terminals will be described with reference to FIG. 7 and FIG. 8.

In FIG. 8, as for the resistance value between the opposite terminals X1 and X2, its reduction degree from the value when one point on the panel is touch as shown in FIG. 7 becomes smaller as the distance between the two points reduces because the resistance (resistance value R4) between the two points touched on the panel reduces. In contrast, its reduction degree from the value when the one point is touched as shown in FIG. 7 increases as the distance between the two points touched on the panel becomes longer because the resistance (resistance value R4) between the two points increases. The same phenomenon occurs between the opposite terminals Y1 and Y2 at both ends of the y direction resistive film TP2. Thus, according to the resistance values between the opposite terminals X1 and X2 and between the opposite terminals Y1 and Y2, the point-to-point distance detecting section 4 can detect the distances between the two points in the x direction and y direction.

The information on the distance between the two points detected at step ST5 is delivered to the point-to-point distance output section 6. Receiving the information on the distance between the two points, the point-to-point distance output section 6 supplies the control section 7 with the information indicating that the two points are touched and the information on the distance between the two points (step ST6). The control section 7 supplies the LCD unit L1 with an appropriate instruction based on the distance between the two points (such instruction as displaying the image by enlarging or reducing in accordance with the distance between the two points). Thus, the LCD unit L1 displays the information corresponding to the distance between the two points on the LCD screen (step ST7).

As described above, the present embodiment 1 includes the touch panel TP having the resistive films TP1 and TP2 which have a pair of terminals (X1 and X2 and Y1 and Y2) at opposite end portions each and are superimposed top and bottom in such a manner that the electrode terminals become orthogonal, wherein the top and bottom resistive films are brought into contact when a resistive film surface is pushed down by touch input; an xy coordinate detecting section 1 for detecting coordinates of the touch position from a touch position at which the resistive films make contact top and bottom in response to the touch input and from voltage values between the electrode terminals; the inter-opposite-terminal resistance measuring section 2 for measuring resistance values between the opposite terminals X1 and X2 in the x direction and the opposite terminals Y1 and Y2 in the y direction; the two-point touch deciding section 3 for making a decision as to whether two points on the touch panel are touched or not from the resistance values between the opposite electrode terminals; and the point-to-point distance detecting section 4 for detecting, when a decision is made that the two points are touched, the distance between the two points touched from the resistance values between the opposite electrode terminals. The configuration enables detecting the distance between the two points touched in the x direction and y direction. This makes it possible to realize the user interface utilizing the distance between the two points due to the two-point touch on the analog touch panel as meaningful input information. For example, the distance between the two points due to the two-point touch can be used as the input information for enlarging or reducing the display of the image on the LCD screen.

### Embodiment 2

The foregoing embodiment 1 is described by way of example of the touch panel device that makes a decision as to whether two points are touched or not using the reduction in the resistance values between opposite terminals measured at the touch on the panel, and detects, when a decision is made that the two points are touched, the distance between the two points from the resistance values between the opposite terminals in the x direction and y direction.

As for the method of making a decision as to whether two points are touched or not using the reduction in the resistance values between opposite terminals, however, it is conceivable that the decision accuracy as to whether two points are touched or not deteriorates when the distance between the two points touched on the panel reduces (in the case of R4→0 in FIG. 8(b)) because it approaches the state in which one point is touched as shown in FIG. 7.

Accordingly, the present embodiment 2 makes a decision as to whether two points are touched or not using the reduction in the resistance values between the orthogonal terminals (between the terminals X1 and Y2, for example), and when making a decision that the two points are touched, it detects the distance between the two points from the resistance values between opposite terminals in the x direction and y direction.

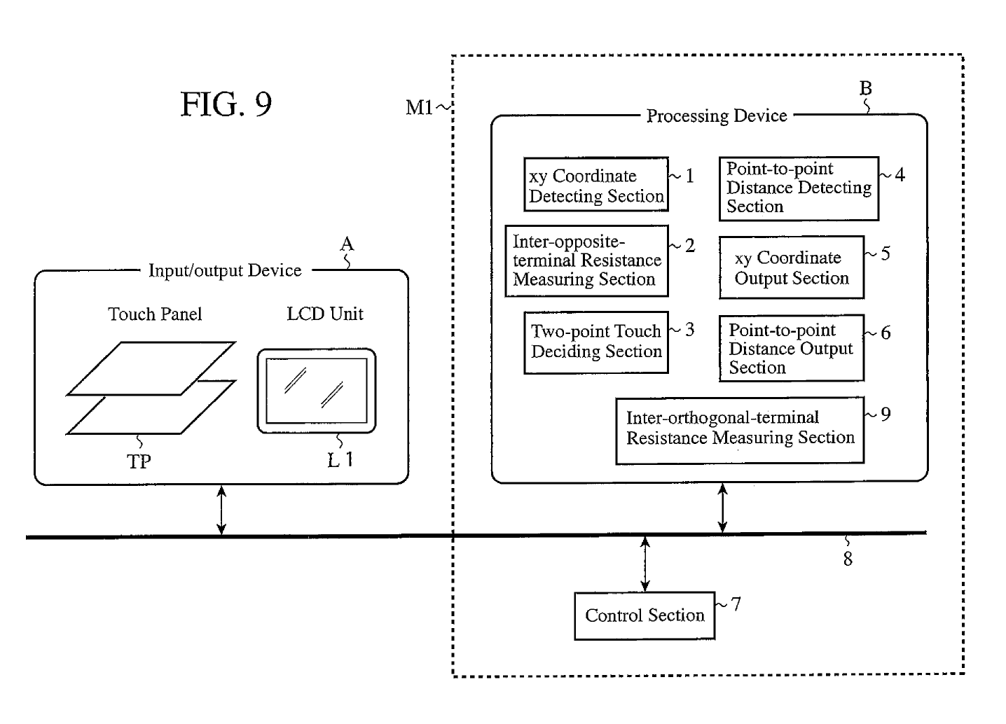

FIG. 9 is a block diagram showing a configuration of the touch panel device of the embodiment 2 in accordance with the present invention. In FIG. 9, the touch panel device of the present embodiment 2 has an inter-orthogonal-terminal resistance measuring section 9 in addition to the configuration of FIG. 1 shown in the foregoing embodiment 1. In the present invention, the resistance value between the orthogonal terminals X1 and Y1, that between the terminals X1 and Y2, that between the terminals X2 and Y1, and that between the terminals X2 and Y2 are referred to as inter-orthogonal-terminal resistance each. The inter-orthogonal-terminal resistance measuring section 9 measures the resistance values between such orthogonal terminals. Incidentally, in FIG. 9, the same or like components as those of FIG. 1 are designated by the same reference symbols, and their redundant explanation will be omitted here. In the following description, FIG. 9 will be used when referring to the configuration of the touch panel device.

Next, the operation will be described.

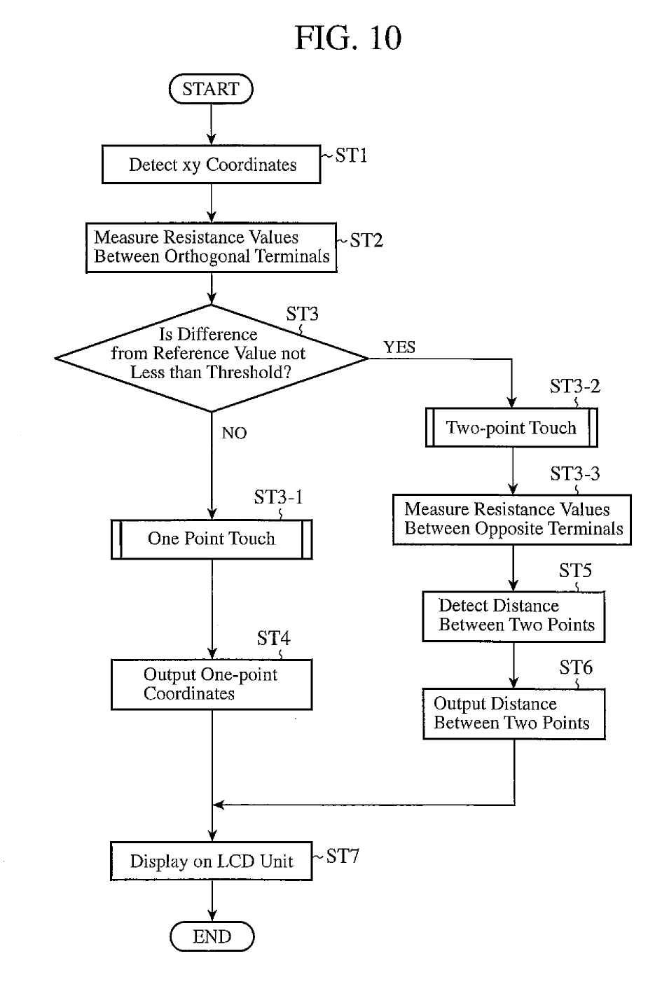

FIG. 10 is a flowchart showing a flow of the xy coordinate detection processing, the decision processing as to whether two points are touched or not, and the processing of detecting the distance between the two points by the touch panel device of the embodiment 2. The present embodiment 2 differs from the foregoing embodiment 1 in the processing that the inter-orthogonal-terminal resistance measuring section 9 measures the four resistance values between the orthogonal terminals at step ST2 of FIG. 10, and in the processing that the inter-opposite-terminal resistance measuring section 2 measures the resistance values between opposite terminals when a decision of the two-point touch is made (step ST8).

First, a method of measuring the resistance values between the orthogonal terminals will be described.

The control section 7 in the microcontroller M1 measures the resistance values between the four terminals by turning on or of f the switches SW1-SW8 by setting the voltages to be applied to the output ports P0-P7, and by reading the voltages input via the input ports ADX1, ADY1, ADX2 and ADY2. For example, to measure the resistance value between the orthogonal terminals X1 and Y2, the control section 7 controls the output values to be applied to the ports P0-P7 in such a manner as to turn on only the switches SW2 and SW8 and to turn off all the other switches.

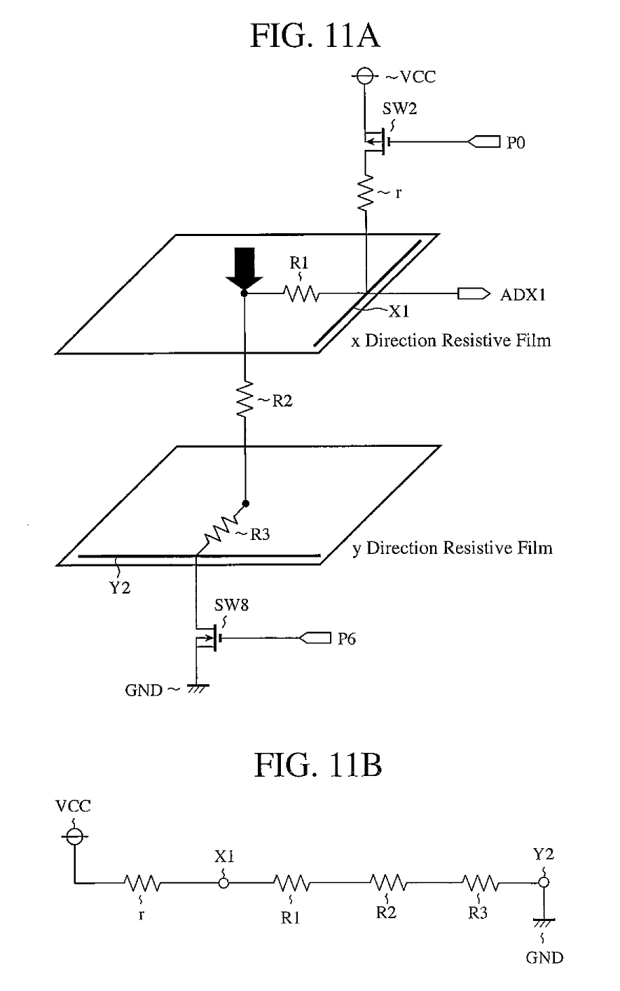

FIG. 11 is a diagram showing an equivalent circuit configuration between the orthogonal terminals X1 and Y2 when one point on the touch panel TP is touched: FIG. 11(a) shows a schematic equivalent circuit when one point is touched; and FIG. 11(b) is an equivalent circuit when one point is touched. When one point is touched in the direction as indicated by the arrow in FIG. 11(a) in the state where only the switches SW2 and SW8 are kept ON, a circuit as shown in FIG. 11(b) is formed between the power supply VCC and the ground GND. The circuit has a reference resistance r with a known resistance value, a resistance (resistance value R1) on the x direction resistive film TP1, a contact resistance (resistance value R2) arising when the x direction resistive film TP1 makes contact with the y direction resistive film TP2, and a resistance (resistance value R3) on the y direction resistive film TP2 connected in series.

In this state, the microcontroller M1 receives the analog signal indicating the voltage value at the input port ADX1 connected to the terminal X1, converts it to a digital signal with an A/D converter not shown, and then outputs it to the inter-orthogonal-terminal resistance measuring section 9. Since the terminal Y2 is connected to the ground, the voltage value at the input port ADX1 becomes the voltage value between the orthogonal terminals X1 and Y2. The inter-orthogonal-terminal resistance measuring section 9 calculates the resistance value between the orthogonal terminals X1 and Y2 using the known voltage value supplied from the power supply VCC, the voltage value between the orthogonal terminals X1 and Y2 and the known resistance value of the reference resistance r.

Likewise, the control section 7 measures the voltage value at the input port ADX1 by controlling the output setting of the output ports P0-P7 in such a manner as to turn on only the switches SW1 and SW2 and to turn off all the other switches, and the inter-orthogonal-terminal resistance measuring section 9 calculates the resistance value between the orthogonal terminals X1 and Y1.

Next, the control section 7 measures the voltage value at the input port ADX2 by controlling the output setting of the output ports P0-P7 in such a manner as to turn on only the switches SW1 and SW6 and to turn off all the other switches, and the inter-orthogonal-terminal resistance measuring section 9 calculates the resistance value between the orthogonal terminals X2 and Y1.

In addition, the control section 7 measures the voltage value at the input port ADX2 by controlling the output setting of the output ports P0-P7 in such a manner as to turn on only the switches SW6 and SW8 and to turn off all the other switches, and the inter-orthogonal-terminal resistance measuring section 9 calculates the resistance value between the orthogonal terminals X2 and Y2 in the same manner. In this way, the four resistance values between the orthogonal terminals (between the terminals X1 and Y2, the terminals X1 and Y1, the terminals X2 and Y1 and the terminals X2 and Y2) are obtained.

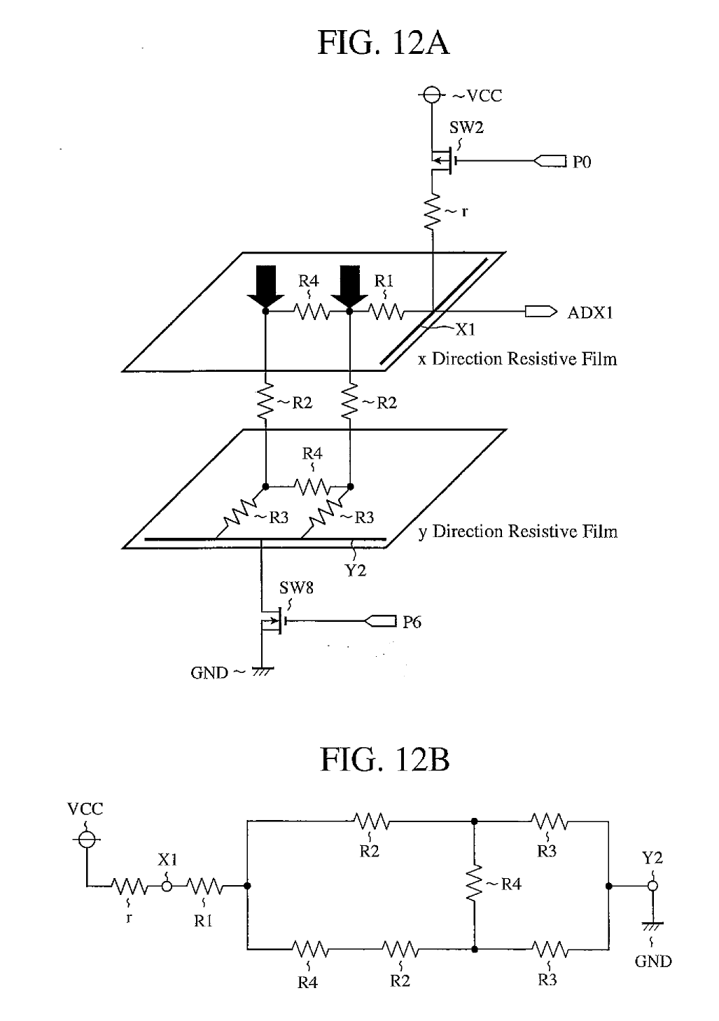

FIG. 12 is a diagram showing an equivalent circuit configuration between the orthogonal terminals X1 and Y2 when two points on the panel of the touch panel TP are touched: FIG. 12(a) shows a schematic equivalent circuit when two points are touched; and FIG. 12(b) is an equivalent circuit when two points are touched. Here, with reference to FIG. 11 and FIG. 12, the principle of the phenomenon that the resistance value between the orthogonal terminals reduces when two points on the panel are touch as compared with when only one point is touched will be described by dividing into the cases where one point is touched and two points are touched.

When a single point on the panel is pushed down in the state where the voltage VCC is applied between the orthogonal terminals X1 and Y2 as shown in FIG. 11, a circuit is formed between the orthogonal terminals X1 and Y2. The circuit has a resistance (resistance value R1) on the x direction resistive film TP1, a contact resistance (resistance value R2) and a resistance (resistance value R3) on the y direction resistive film TP2 connected in series.

In contrast, when two points on the panel are pushed down as indicated by the arrows in FIG. 12(a) while applying the voltage VCC between the orthogonal terminals X1 and Y2, a circuit is formed between the orthogonal terminals X1 and Y2 as shown in FIG. 12(b). The circuit has, via the resistance (resistance value R1) on the x direction resistive film TP1, the contact resistances (resistance value R2), the resistances (resistance value R3) on they direction resistive film TP2 and the resistances (resistance value R4) between the two points pushed, which are connected in parallel.

In this case, as the resistance value R4 of the resistance across the two points pushed down reduces, that is, as the distance between the two points becomes short, the resistance value between the orthogonal terminals X1 and Y2 approaches the minimum value (R1+(R2+R3)/2) (when R4→0). In contrast, as the resistance value R4 increases, that is, as the distance between the two points increases, the resistance value between the orthogonal terminals X1 and Y2 approaches the maximum value (R1+R2+R3) (when R4→∞)).

Thus, the resistance value between the orthogonal terminals X1 and Y2 increases in a monotone with respect to the resistance value R4 as expressed by the following inequality (1). Accordingly, the resistance value between the orthogonal terminals X1 and Y2 when the two points are touched is less than the resistance value between the orthogonal terminals X1 and Y2 (R1+R2+R3) when one point is touched. Incidentally, the relationship in the following expression (1) is also applicable to the other three orthogonal terminals (between the terminals X1 and Y1, the terminals X2 and Y1 and the terminals X2 and Y2).

(R1+(R2+R3)/2)<resistance value between orthogonal terminals X1 and Y2<(R1+R2+R3) (1)

In the two-point touch decision method utilizing the reduction in the resistance value between opposite terminals described in the foregoing embodiment 1, as the distance between the two points becomes short, the condition approaches the state where one point is touched. Thus, the decision accuracy as to whether one point is touch or two points are touched reduces. In contrast with this, in the two-point touch decision method utilizing the resistance between the orthogonal terminals in the present embodiment 2, even if the distance between the two points is very small, the condition does not approach the state where one point is touched. Consequently, the present embodiment 2 offers an advantage of being able to prevent the deterioration in the decision accuracy as to whether one point is touched or two points are touched.

Let us return to the description of FIG. 9. According to the principle described above, the two-point touch deciding section 3 receives the resistance value between the orthogonal terminals measured at step ST2, calculates the difference between the resistance between the orthogonal terminals and the specified reference value, and makes a decision as to whether the difference is equal to or greater than a specified threshold (step ST3). If the difference is less than the threshold, the two-point touch deciding section 3 decides that one point is touched (step ST3-1), and notifies the xy coordinate output section 5 of it.

On the other hand, if the difference between the resistance between orthogonal terminals and the reference value is equal to or greater than the threshold at step ST3, the two-point touch deciding section 3 decides that the two points are touched (step ST3-2), and notifies the inter-opposite-terminal resistance measuring section 2 of the decision result. Receiving the decision result indicating that the two points are touched, the inter-opposite-terminal resistance measuring section 2 measures the resistance values between opposite terminals by the method described in the foregoing embodiment 1 (step ST3-3). In addition, using the resistance values between opposite terminals the inter-opposite-terminal resistance measuring section 2 measures, the point-to-point distance detecting section 4 detects the distance between the two points (step ST5). Since the processing after that is the same as that of FIG. 3, the description thereof will be omitted here.

As described above, in the present embodiment 2, using the resistance between the orthogonal terminals the inter-orthogonal-terminal resistance measuring section 9 measures, the two-point touch deciding section 3 decides as to whether one point is touched or two points are touched. This offers an advantage of being able to prevent the deterioration in the decision accuracy as to whether one point is touched or two points are touched even if the distance between the two points are very short.

### Embodiment 3

The foregoing embodiments 1 and 2 are described by way of example of the touch panel device that decides as to whether two points are touched or not using the resistance values between the opposite terminals or between the orthogonal terminals, and detects the distance between the two points from the resistance values between the opposite terminals on the panel. The present embodiment 3, in addition to the touch panel device described in the foregoing embodiment 1 or 2, has the function of outputting, when the decision of the two-point touch is made, the information on the distance between the two points the point-to-point distance detecting section 4 detects from the resistance values between the opposite terminals, and the xy coordinates near the middle point between the touched points the xy coordinate detecting section 1 detects.

Although the touch panel device of the present embodiment 3 has basically the same configuration as that of the foregoing embodiment 1 or 2, it differs in that the xy coordinate output section 5 outputs the xy coordinates to the control section 7 even when the two-point touch deciding section 3 makes a decision that two points are touched.

Next, the operation will be described.

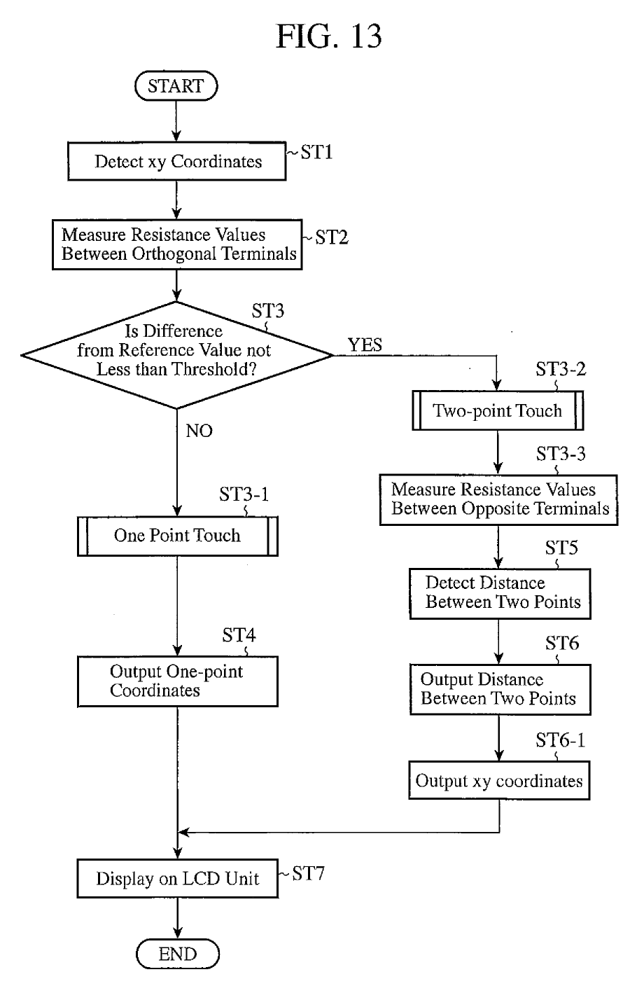

FIG. 13 is a flowchart showing a flow of the xy coordinate detection processing, the decision processing as to whether two points are touched or not, and the processing of detecting the distance between the two points by the touch panel device of the embodiment 3 in accordance with the present invention. Here, FIG. 13 shows an example that employs the method described in the foregoing embodiment 2 for making a decision as to whether two points are touched or not. However, when applying the embodiment 3, the method described in the foregoing embodiment 1 can also be used as the decision processing of the two-point touch.

When the two-point touch deciding section 3 makes a decision of the two-point touch, the point-to-point distance output section 6 supplies the control section 7 with the information indicating that the two-points are touched and the information on the distance between the two points at step ST6 in FIG. 13. After that, the xy coordinate output section 5 supplies the control section 7 with the xy coordinates the xy coordinate detecting section 1 detects at step ST1 (step ST6-1).

In the case of the two-point touch, the xy coordinates the xy coordinate detecting section 1 detects are the xy coordinates near the middle point between the two points touched. Next, the control section 7 supplies the LCD unit L1 with an appropriate instruction based on the xy coordinates near the middle point between the two points supplied from the xy coordinate detecting section 1 and the information on the distance between the two points (such instruction as displaying the image by enlarging or reducing it in accordance with the xy coordinates near the middle point and the distance between the two points). Thus, the LCD unit L1 displays the information corresponding to the xy coordinates near the middle point and the distance between the two points on the LCD screen (step ST7) Since the remaining processing is the same as that described with reference to FIG. 10 of the foregoing embodiment 2, the description thereof will be omitted here.

As described above, according to the present embodiment 3, when a decision of the two-point touch is made, the point-to-point distance output section 6 outputs the information on the distance between the two points and the xy coordinate output section 5 outputs the xy coordinate information (the xy coordinate information near the middle point between the two points). Thus, the present embodiment 3 can realize the user interface that makes use of both the xy coordinates near the middle point between the two points touched on the panel and the distance between the two points as the meaningful input information. For example, the xy coordinates near the middle point between the two points touched on the panel and the distance between the two points can be used as the input information for displaying the image on the LCD screen by enlarging or reducing it.

### Embodiment 4

The present embodiment 4 is a user interface device for displaying on an LCD screen an image or document by enlarging or reducing it in accordance with the distance between the two points detected when a decision is made that the two points are touched by using the touch panel device of the foregoing embodiment 1 or 2.

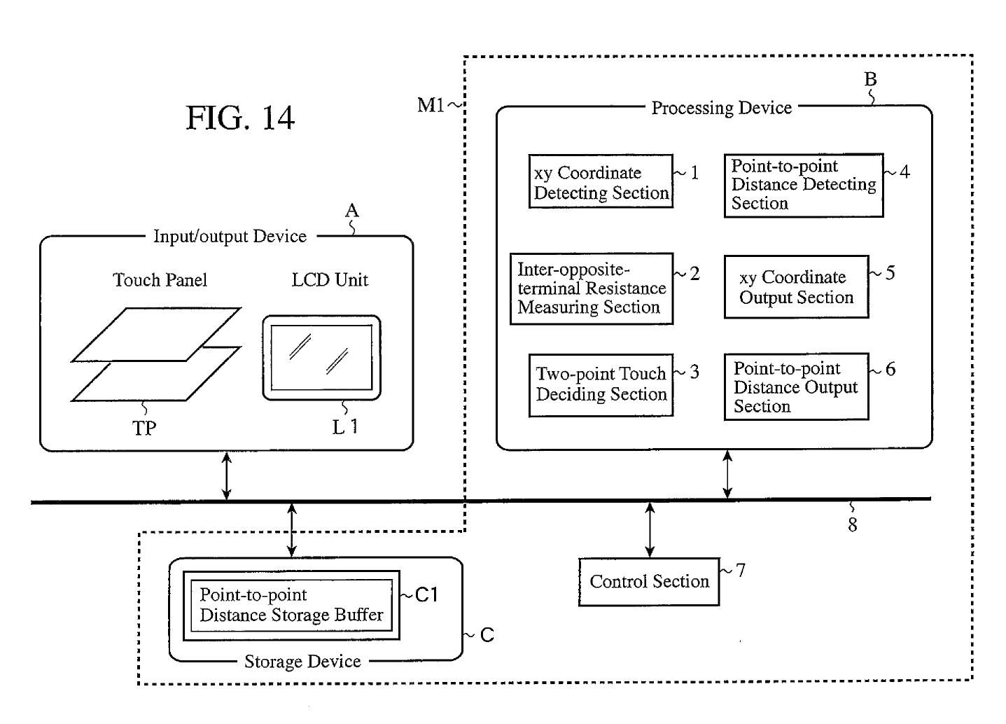

FIG. 14 is a block diagram showing a configuration of the touch panel device of the embodiment 4 in accordance with the present invention. In FIG. 14, the user interface device of the present embodiment 4 has a storage device C including a point-to-point distance storage buffer C1 in addition to the configuration of FIG. 1 shown in the foregoing embodiment 1. The storage device C is connected to the input/output device A, processing device B and control section 7 via the signal line 8, and is constructed within the microcontroller M1 in the circuit diagram shown in FIG. 1.

The point-to-point distance storage buffer C1, which is provided for storing the information on the distance between the two points one unit time before, is constructed on a storage area of the storage device C. In FIG. 14, the same or like components to those of FIG. 1 are designated by the same reference symbols, and their redundant description will be omitted here. In the following description, FIG. 14 will be used when referring to the configuration of the touch panel device.

Next, the operation will be described.

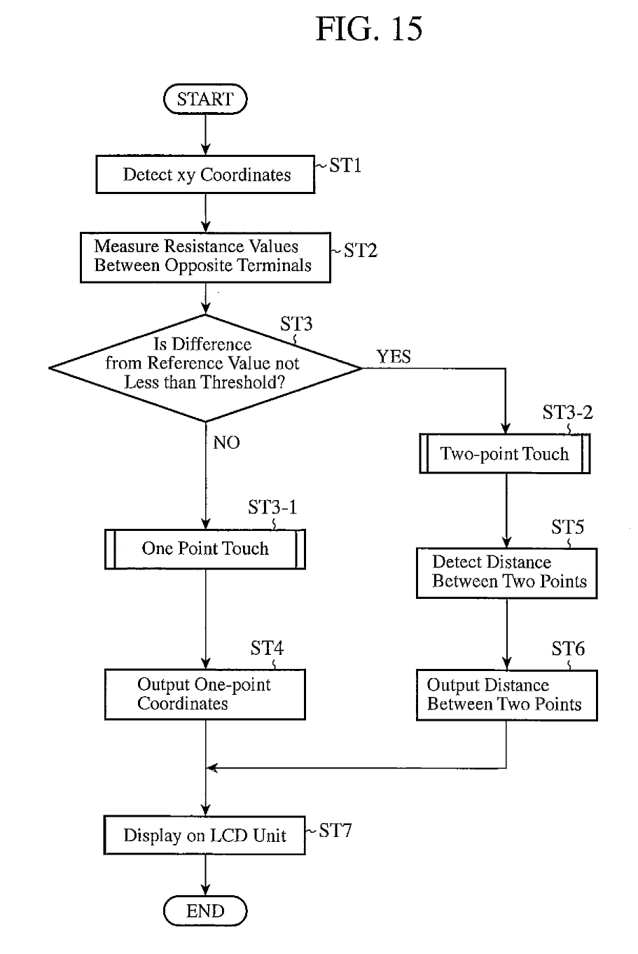

FIG. 15 is a flowchart showing a flow of the xy coordinate detection processing, the decision processing as to whether two points are touched or not, the processing of detecting the distance between the two points, and the enlarging or reducing processing of the image or document in accordance with the distance between the two points by the user interface device of the embodiment 4. Here, FIG. 15 shows an example that employs the method described in the foregoing embodiment 1 for making a decision as to whether two points are touched or not. However, when applying the embodiment 4, the method of using the reduction in the resistance value between the orthogonal terminals described in the foregoing embodiment 2 can also be used as the decision processing of the two-point touch.

In FIG. 15, the xy coordinate detection processing (step ST1) the inter-opposite-terminal resistance measurement processing (step ST2), the two-point touch decision processing (steps ST3, ST3-1, and ST3-2), the one point coordinate output processing (step ST4), the point-to-point distance detecting processing (step ST5) and the point-to-point distance output processing (step ST6) are the same as those of the foregoing embodiment 1, and hence their description will be omitted here.

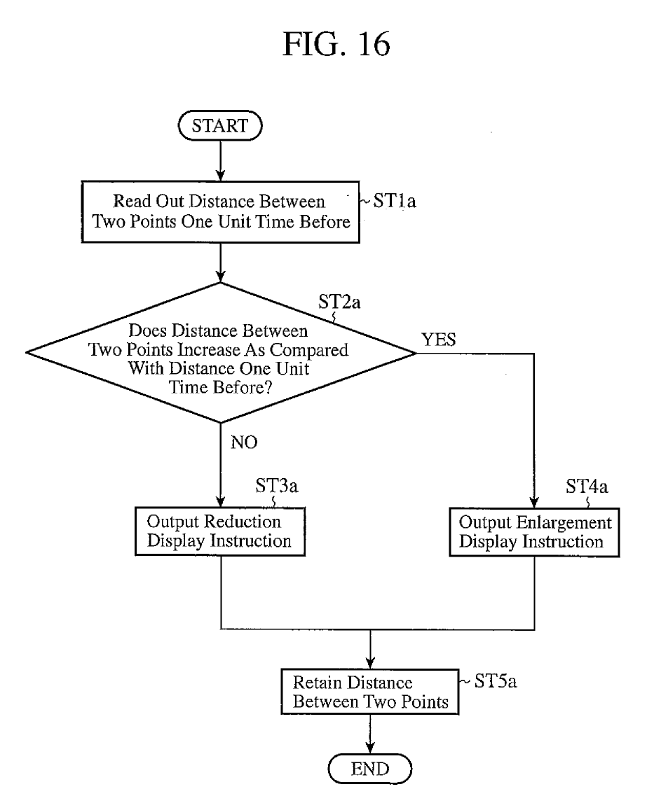

FIG. 16 is a flowchart showing a detailed flow of the processing designated by the reference symbol A in FIG. 15, which displays an image or document by enlarging or reducing it in accordance with the distance between the two points. Receiving the information on the distance between the two points from the point-to-point distance output section 6 at step ST6 shown in FIG. 15, the control section 7 reads the distance between the two points one unit time before stored in the point-to-point distance storage buffer C1 (step ST1a).

Next, the control section 7 calculates the difference between the distance between the two points at the present time input from the point-to-point distance output section 6 and the distance between the two points one unit time before. Then it makes a decision as to whether the current distance between the two points is greater than the distance between the two points one unit time before according to the difference between the distances between the two points (step ST2a).

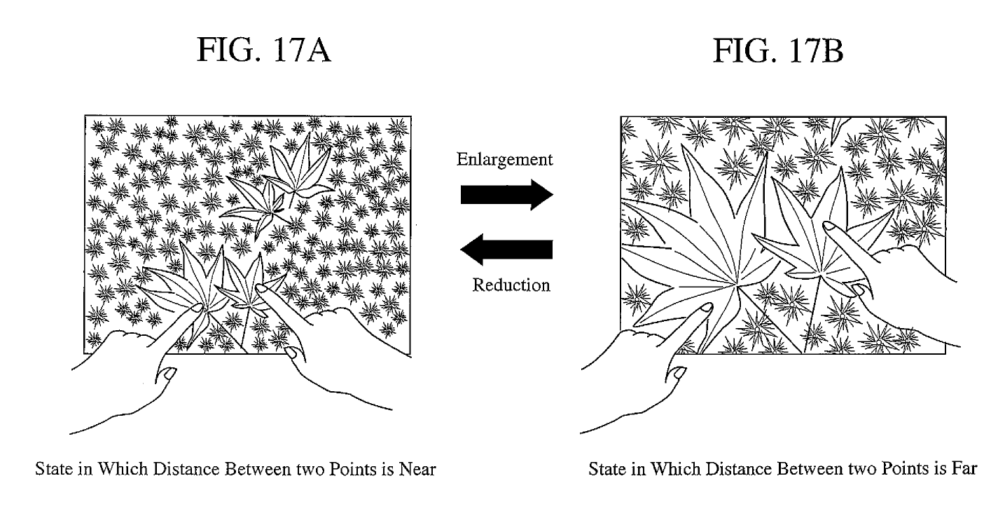

FIG. 17 is a diagram for explaining the alteration processing of the display contents in accordance with the distance between the two points due to the two-point touch. At step ST2a, if the current distance between the two points is smaller than the distance between the two points one unit time before, the control section 7 supplies the LCD unit L1 with an instruction to perform reduction display of the image or document the LCD unit L1 displays now at a reduction ratio based on the difference (step ST3a).

In the example of FIG. 17, assume that the two-point touch is carried out successively in the state where fallen leaves are displayed large as shown in FIG. 17(b), and that the distance between the two points due to the two-point touch at the present time is smaller than the distance between the two points due to the two-point touch one unit time before. Then, the image is altered from the state of FIG. 17(b) to the reduced display state as shown in FIGS. 17(a) in accordance with the difference between the distances between the two points.

In contrast, when the current distance between the two points is greater than the distance between the two points one unit time before, the control section 7 supplies the LCD unit L1 with an instruction to perform enlargement display of the image or document the LCD unit L1 displays now at an enlargement ratio in accordance with the difference (step ST4a). In the example of FIG. 17, assume that the two-point touch is carried out successively in the state where fallen leaves are displayed small as shown in FIG. 17(a), and that the distance between the two points due to the two-point touch at the present time is greater than the distance between the two points due to the two-point touch one unit time before. Then, the image is altered from the state of FIG. 17(a) to the enlarged display state as shown in FIG. 17(b) in accordance with the difference between the distances between the two points.

After executing the processing at step ST3a or step ST4a, the control section 7 stores the information on the distance between the two points into the point-to-point distance storage buffer C1 (step ST5a). After that, the LCD unit L1 displays the image or document on the LCD screen in accordance with the instruction supplied from the control section 7 at step ST4 or in the processing designated by the reference symbol A shown in FIG. 15 (step ST7).

As described above, according to the present embodiment 4, when a decision of the two-point touch is made, the control section 7 enlarges or reduces the image or document displayed on the LCD screen in accordance with the difference between the distance between the two points at the present time and the distance between the two points one unit time before the point-to-point distance output section 6 outputs as shown in FIG. 17, that is, in accordance with the difference between the distances between the two points touched in a time sequence. In this way, the present embodiment 4 can realize the user interface device capable of altering the display picture intuitively by the two-point touch operation.

### Embodiment 5

The present embodiment 5 is a user interface device for displaying on an LCD screen an image or document by enlarging or reducing it in accordance with the xy coordinates detected (coordinates near the middle point between the two points) and the distance between the two points detected when a decision is made that the two points are touched by using the touch panel device of the foregoing embodiment 3. The user interface device of the present embodiment 5 has the same configuration as that of the foregoing embodiment 4 shown in FIG. 14.

Next, the operation will be described.

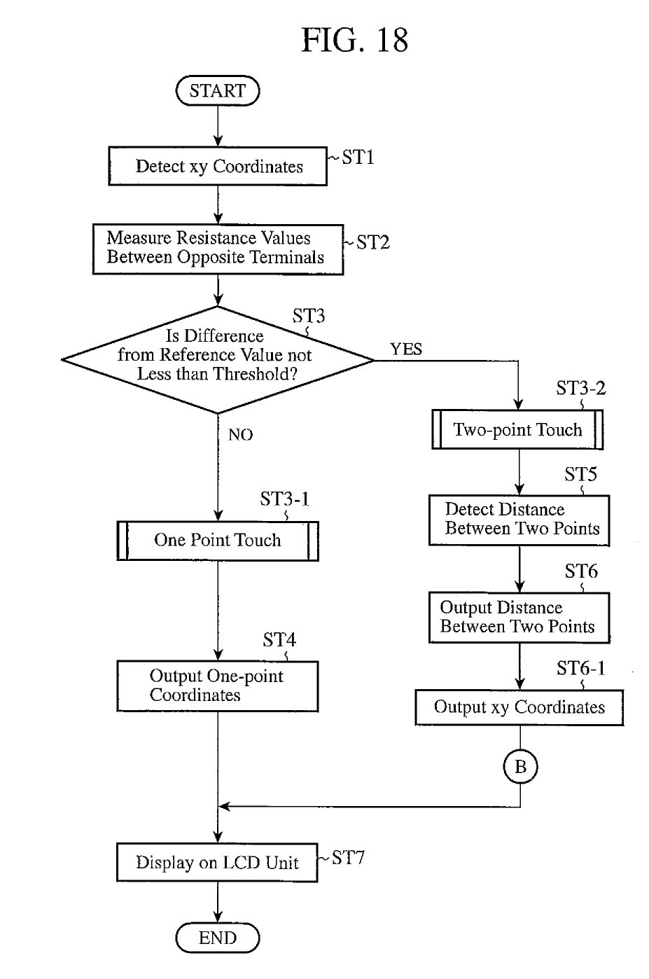

FIG. 18 is a flowchart showing a flow of the xy coordinate detection processing, the decision processing as to whether two points are touched or not, the processing of detecting the distance between the two points, and the enlarging or reducing display processing of the image or document in accordance with the xy coordinates near the middle point between the two points and the distance between the two points by the user interface device of the embodiment 5. Here, FIG. 18 shows an example that employs the method described in the foregoing embodiment 1 for making a decision as to whether two points are touched or not. However, when applying the embodiment 5, the method of using the reduction in the resistance value between the orthogonal terminals described in the foregoing embodiment 2 can also be used as the decision processing of the two-point touch.

In FIG. 18, the xy coordinate detection processing (step ST1), the inter-opposite-terminal resistance measurement processing (step ST2), the two-point touch decision processing (steps ST3, ST3-1, and ST3-2), the one point coordinate output processing (step ST4), the point-to-point distance detecting processing (step ST5), the point-to-point distance output processing (step ST6) and the xy coordinate output processing (step ST6-1) are the same as those of the foregoing embodiment 3, and hence their description will be omitted here.

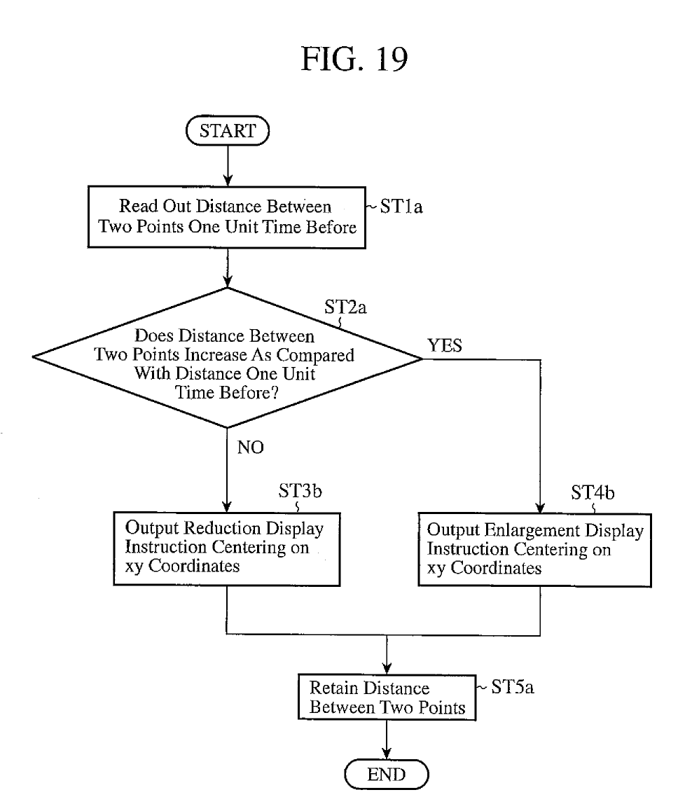

FIG. 19 is a flowchart showing a detailed flow of the processing designated by the reference symbol B in FIG. 18, which displays an image or document by enlarging or reducing it in accordance with the xy coordinates near the middle point between the two points and the distance between the two points. In FIG. 19, when the point-to-point distance output section 6 supplies the control section 7 with the information on the distance between the two points, the control section 7 reads out the information on the distance between the two points one unit time before, which is stored in the point-to-point distance storage buffer C1, in the same manner as in the foregoing embodiment 4 (step ST1a).

Next, the control section 7 calculates the difference between the information on the distance between the two points input from the point-to-point distance output section 6 and the information on the distance between the two points one unit time before. Then it makes a decision as to whether the distance between the two points input from the point-to-point distance output section 6 is greater than the distance between the two points one unit time before or not according to the difference between the distances between the two points (step ST2a).

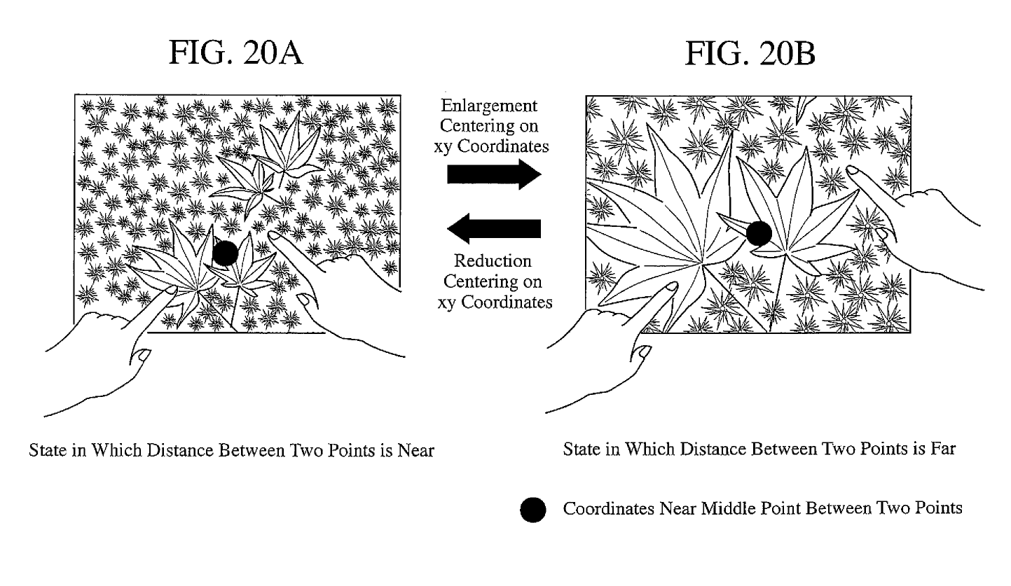

FIG. 20 is a diagram for explaining the alteration processing of the display contents in accordance with the xy coordinates near the middle point between the two points due to a two-point touch and the distance between the two points. At step ST2a, if the current distance between the two points is smaller than the distance between the two points one unit time before, the control section 7 supplies the LCD unit L1 with an instruction to perform reduction display of the image or document the LCD unit L1 displays now at a reduction ratio based on the difference so that the xy coordinates (coordinates near the middle point between the two points) input from the xy coordinate output section 5 come to the center of the LCD screen (step ST3b).

In the example of FIG. 20, assume that the two-point touch is carried out successively in the state where fallen leaves are displayed large as shown in FIG. 20(b), and that the distance between the two points due to the two-point touch at the present time is smaller than the distance between the two points due to the two-point touch one unit time before. Then, the display state is altered in such a manner that the image of the fallen leaves is reduced from the state shown in FIG. 20(b) to the state as shown in FIG. 20(a) in accordance with the difference between the distances between the two points, and that the coordinates near the middle point between the two points due to the two-point touch are located at the center of the LCD screen.

In contrast, when the current distance between the two points is greater than the distance between the two points one unit time before, the control section 7 supplies the LCD unit L1 with an instruction to perform enlargement display of the image or document the LCD unit L1 displays now at an enlargement ratio based on the difference so that the xy coordinates (coordinates near the middle point between the two points) supplied from the xy coordinate output section 5 come to the center of the LCD screen (step ST4b).

In the example of FIG. 20, assume that the two-point touch is carried out successively in the state where fallen leaves are displayed small as shown in FIG. 20(a), and that the distance between the two points due to the two-point touch at the present time is greater than the distance between the two points due to the two-point touch one unit time before. Then, the display state is altered in such a manner that the image of the fallen leaves is enlarged from the state shown in FIG. 20(a) to the state shown in FIG. 20(b) in accordance with the difference between the distances between the two points, and that the coordinates near the middle point between the two points due to the two-point touch are located at the center of the LCD screen.

After executing the processing at step ST3b or step ST4b, the control section 7 stores the information on the distance between the two points into the point-to-point distance storage buffer C1 (step ST5a). After that, the LCD unit L1 displays the image or document on the LCD screen in accordance with the instruction supplied from the control section 7 at step ST4 or in the processing designated by the reference symbol B shown in FIG. 18 (step ST7).

As described above, according to the present embodiment 5, when a decision of the two-point touch is made, the control section 7 enlarges or reduces the image or document displayed on the LCD screen as shown in FIG. 20 in accordance with the xy coordinates (coordinates near the middle point between the two points) input from the xy coordinate output section 5 and the difference between the distance between the two points input from the point-to-point distance output section 6 and the distance between the two points one unit time before. In this way, the present embodiment 5 can realize the user interface device capable of altering the display picture intuitively by the two-point touch operation.

### Embodiment 6

The present embodiment 6 is a user interface device for performing rotation display of an image or document in accordance with the xy coordinates detected (coordinates near the middle point between the two points) and the x and y direction distances between the two points detected when a decision is made that the two points are touched by using the touch panel device of the foregoing embodiment 3. The user interface device of the present embodiment 6 has the same configuration as that of the foregoing embodiment 4 shown in FIG. 14.

Next, the operation will be described.

As for the xy coordinate detection processing and the decision processing as to whether two points are touched or not by the user interface device of the embodiment 6, they are the same as the xy coordinate detection processing (step ST1), the inter-opposite-terminal resistance measurement processing (step ST2), the two-point touch decision processing (steps ST3, ST3-1, and ST3-2), the one point coordinate output processing (step ST4), the point-to-point distance detecting processing (step ST5), the point-to-point distance output processing (step ST6) and the xy coordinate output processing (step ST6-1) in FIG. 18 described in the foregoing embodiment 5.

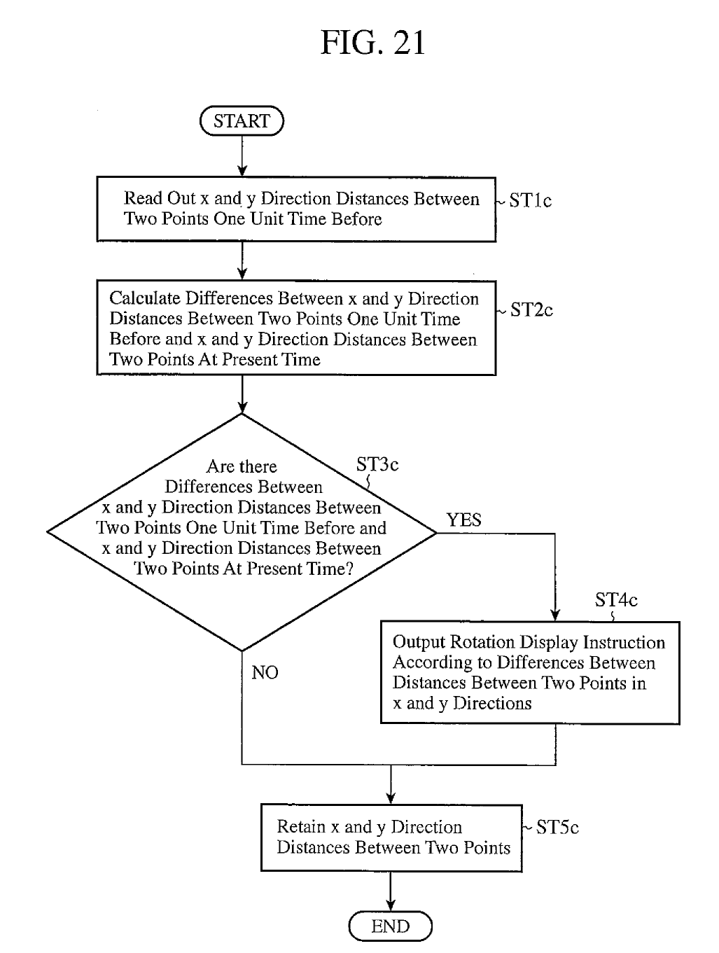

FIG. 21 is a flowchart showing a flow of the processing designated by the reference symbol B in FIG. 18, which is executed the user interface device of the embodiment 6 in accordance with the present invention. It shows a detailed flow of rotation display processing of an image or document in accordance with the xy coordinates near the middle point between the two points and the x and y direction distances between the two points. In FIG. 21, when the point-to-point distance output section 6 supplies the control section 7 with the information on the x and y direction distances between the two points, the control section 7 reads out the information on the x and y direction distances between the two points one unit time before stored in the point-to-point distance storage buffer C1 (step ST1c).

Next, the control section 7 calculates the differences between the current x and y direction distances between the two points input from the point-to-point distance output section 6 and the x and y direction distances between the two points one unit time before (step ST2c). According to the differences between the distances between the two points, the control section 7 makes a decision as to whether the current x and y direction distances between the two points supplied from the point-to-point distance output section 6 are greater than the x and y direction distances between the two points one unit time before (step ST3c). Here, in addition to the large and small of the distances between the two points, the control section 7 also makes a decision as to changes in the positive or negative direction on the axes in the xy coordinate system set on the touch panel TP.

At step ST3c, when there are differences in the x and y direction distances between the two points, the control section 7 supplies the LCD unit L1 with an instruction to perform rotation display of an image or document the LCD unit L1 displays now about the xy coordinates (coordinates near the middle point between the two points) supplied from the xy coordinate output section 5 in accordance with the differences (step ST4c).

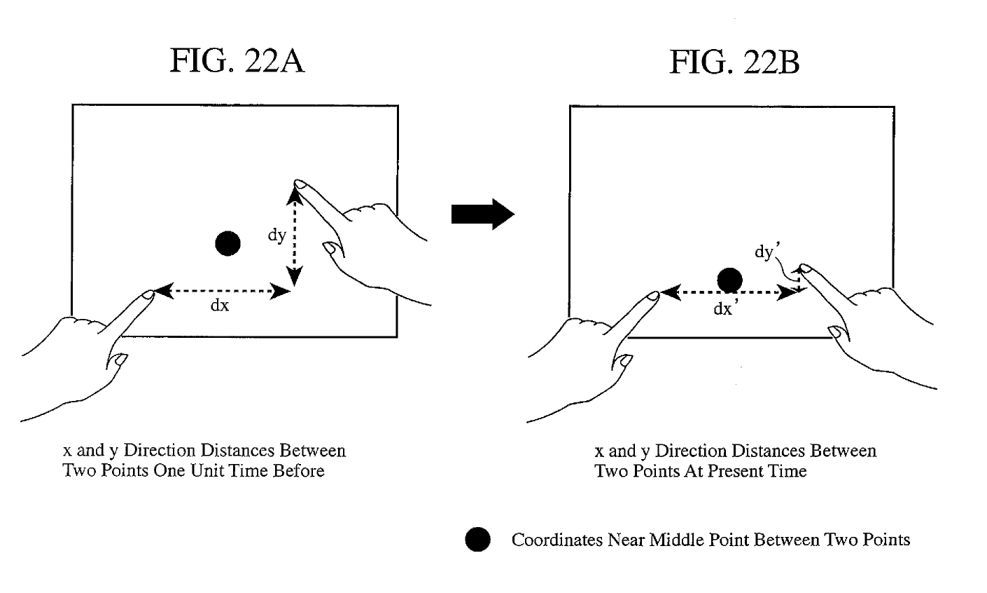

FIG. 22 is a diagram for explaining the differences between the distances between the two points in the x and y directions one unit time before and at the present time. In FIG. 22, the difference between the distance dx between the two points in the x direction one unit time before shown in FIG. 22(a) and the distance dx′ between the two points in the x direction at the present time shown in FIG. 22(b) is small. In contrast, the difference between the distance dy between the two points in the y direction one unit time before shown in FIG. 22(a) and the distance dy′ between the two points in the y direction at the present time shown in FIG. 22(b) is large in the negative direction as compared with the difference between the distances between the two points in the x direction one unit time before and at the present time.

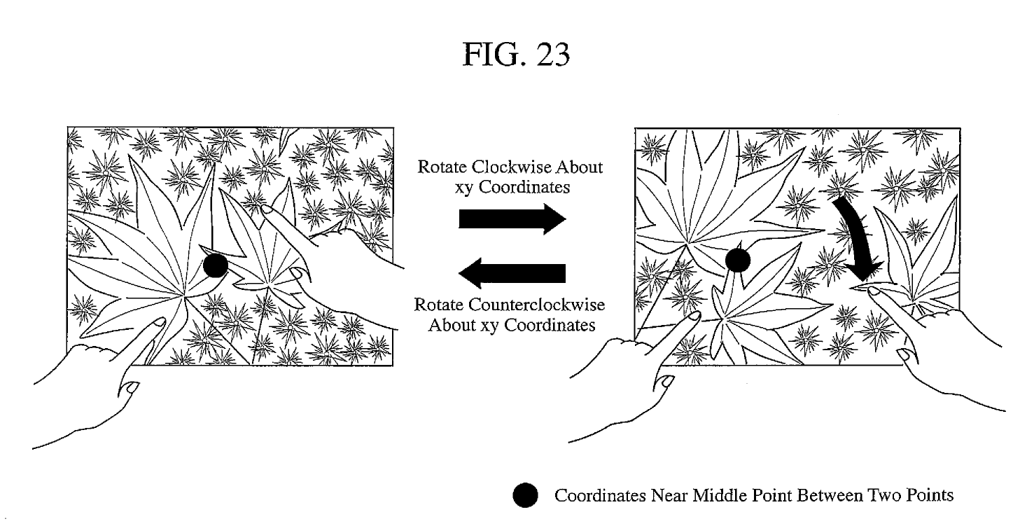

FIG. 23 is a diagram for explaining the processing of performing the rotation display of the display contents about the xy coordinates near the middle point between the two points due to the two-point touch. At step ST3c, if the control section 7 obtains the decision result that the difference between the distances between the two points in the x direction is small as shown in FIG. 22 and the difference between the distances between the two points in the y direction is large in the negative direction, the control section 7 supplies the LCD unit L1 with an instruction to perform the rotation display clockwise about the coordinates near the middle point between the two points as shown in the right-hand figure of FIG. 23.

On the contrary, if the touch is changed from the touch position shown in FIG. 22(b) to that shown in FIG. 22(a), the control section 7 obtains the decision result that the difference between the distances between the two points in the x direction is small, and the difference between the distances between the two points in the y direction is large in the positive direction. Thus, the control section 7 supplies the LCD unit L1 with an instruction to perform the rotation display counterclockwise about the coordinates near the middle point between the two points as shown in the left-hand figure of FIG. 23.

On the other hand, if the control section 7 makes a decision at step ST3c that there are substantially no differences between the distances between the two points in the x and y directions one unit time before and at the present time, the control section 7 does not supply any instruction to the LCD unit L1. After that, the control section 7 stores the information on the distances between the two points in the x and y directions input from the point-to-point distance output section 6 into the point-to-point distance storage buffer C1 (step ST5c). When receiving the foregoing instruction from the control section 7 in the processing at step ST4c shown in FIG. 21, the LCD unit L1 displays image or document on the LCD screen in the same manner as in step ST7 of FIG. 18 in accordance with the instruction.

As described above, according to the present embodiment 6, when a decision of the two-point touch is made, the control section 7 carries out the rotation display of the image or document displayed on the LCD screen in accordance with the xy coordinates (coordinates near the middle point between the two points) input is from the xy coordinate output section 5 and the differences between the distances between the two points in the x and y directions at the present time and one unit time before input from the point-to-point distance output section 6, that is, the differences between the distances between the two points touched in time sequence as shown in FIG. 23. In this way, the present embodiment 6 can realize the user interface device capable of altering the display picture intuitively by the two-point touch operation.

What is claimed is:

1. A touch panel device including a touch panel having resistive films which have electrode terminals at opposite end portions each and are superimposed top and bottom in a manner that the electrode terminals become orthogonal, wherein the top and bottom resistive films are brought into contact with each other by pushing a resistive film surface by touch input, the touch panel device comprising:
a coordinate detecting section for detecting coordinates of a touch position from voltage values between the electrode terminals and the touch position at which the resistive films make contact top and bottom in response to the touch input onto the touch panel;
an inter-opposite-terminal resistance measuring section for measuring resistance values between the opposite electrode terminals of the top and bottom resistive films;
a two-point touch deciding section for making a decision as to whether two points on the touch panel are touched or not from the resistance values between the opposite electrode terminals measured by the inter-opposite-terminal resistance measuring section; and
a point-to-point distance detecting section for detecting, when the two-point touch deciding section decides that the two points are touched, the distance between the two points touched from the resistance values between the opposite electrode terminals measured by the inter-opposite-terminal resistance measuring section.

2. A touch panel device including a touch panel having resistive films which have electrode terminals at opposite end portions each and are superimposed top and bottom in a manner that the electrode terminals become orthogonal, wherein the top and bottom resistive films are brought into contact with each other by pushing a resistive film surface by touch input, the touch panel device comprising:
a coordinate detecting section for detecting coordinates of a touch position from voltage values between the electrode terminals and the touch position at which the resistive films make contact top and bottom in response to the touch input onto the touch panel;
an inter-orthogonal-terminal resistance measuring section for measuring resistance values between the orthogonal electrode terminals of the top and bottom resistive films;
an inter-opposite-terminal resistance measuring section for measuring resistance values between the opposite electrode terminals of the top and bottom resistive films;
a two-point touch deciding section for making a decision as to whether two points on the touch panel are touched or not from the resistance values between the orthogonal electrode terminals measured by the inter-orthogonal-terminal resistance measuring section; and
a point-to-point distance detecting section for detecting, when the two-point touch deciding section decides that the two points are touched, the distance between the two points touched from the resistance values between the opposite electrode terminals measured by the inter-opposite-terminal resistance measuring section.

3. A user interface device comprising:
a touch panel device as defined in claim 1 or 2; and
a control section for controlling display contents on a display section superimposed on the touch panel in accordance with at least one of the coordinates of the touch position detected by the coordinate detecting section and the distance between the two points detected by the point-to-point distance detecting section.

4. The user interface device according to claim 3, wherein
the control section controls display magnification of the display contents in accordance with magnitude of time-series variations in difference between respective distances between two points detected in time-series two-point touch input by the point-to-point distance detecting section.

5. The user interface device according to claim 4, wherein
the control section obtains coordinates of the middle point between the two points from coordinates of the touch positions detected by the coordinate detecting section, and controls a display position of the display contents in a manner that the middle point between the two points is located at a center of a display screen of the display section.

6. The user interface device according to claim 3, wherein
the control section controls rotation display of the display contents by obtaining time-series variations in the x direction and y direction on a display screen of the display section, the time-series variations being variations in difference between respective distances between two points detected in time-series two-point touch input by the point-to-point distance detecting section; and by deciding a direction of rotation in accordance with magnitude relationships of the variations in the x direction and y direction.
